(19) United States
(12) Patent Application Publication
(10) Pub. No.: US 2026/0295576 A1
(43) Pub. Date: Oct. 1, 2026

(54) SAMPLE HOLDER, ANALYSIS SYSTEM, AND METHOD FOR ANALYZING SAMPLE

(71) Applicant: Kioxia Corporation, Tokyo (JP)

(72) Inventors: Risa MORIYAMA, Yokkaichi Mie (JP); Jiahong WU, Yokkaichi Mie (JP)

(21) Appl. No.: 19/557,994

(22) Filed: Mar. 5, 2026

(30) Foreign Application Priority Data
Mar. 28, 2025 (JP) 2025-054771
Aug. 12, 2025 (CN) 202511124617.9
Aug. 12, 2025 (TW) 114130754

(51) Int. Cl. B01L 3/00

(52) U.S. Cl. CPC B01L 3/50; B01L 2200/025; B01L 2300/048; B01L 2300/0809

(57) ABSTRACT

A sample holder includes a sample chamber, a laser guide, a first introduction pipe, and a delivery pipe. The sample chamber includes a surface having a through hole and configured to accommodate a sample along the surface. The laser guide extends in a first direction crossing the surface of the sample chamber between a first end connected to the through hole and a second end opposite to the first end. A window capable of transmitting a laser beam is provided at the second end of the laser guide. The first introduction pipe is provided on a first side of the sample chamber to introduce a carrier gas into the sample chamber. The delivery pipe is provided on a second side of the sample chamber to deliver a substance released from the sample by application of the laser beam.

### CROSS-REFERENCE TO RELATED APPLICATIONS

This application is based upon and claims the benefit of priority from Japanese Patent Application No. 2025-054771, filed Mar. 28, 2025, Chinese Patent Application No. 202511124617.9, filed Aug. 12, 2025, and Taiwanese Patent Application No. 114130754, filed Aug. 12, 2025, the entire contents of which are incorporated herein by reference.

### FIELD

Embodiments described herein relate generally to a sample holder, an analysis system, and a method for analyzing a sample.

### BACKGROUND

There is known a laser ablation-inductively coupled plasma analysis system (LA-ICP analysis system), which analyzes a sample by means of a process of releasing constituents on the surface of the sample by applying a laser beam to the surface of the sample (referred to as laser ablation). For example, a laser ablation-inductively coupled plasma-mass spectrometer (LA-ICP-MS) system performs mass spectrometry for constituents of a sample using laser ablation. In such an analysis system, substances released from the sample by the laser ablation may adhere to a window that transmits the laser beam to be applied to the sample, which causes a deterioration in the transmittance of the laser beam, resulting in a deterioration in accuracy of the analysis.

### BRIEF DESCRIPTION OF THE DRAWINGS

FIG. 1 is a diagram illustrating a configuration example of an LA-ICP-MS system according to a first embodiment.

FIG. 2 illustrates a perspective view of a sample holder in the first embodiment.

FIG. 3 illustrates a top view of the sample holder in the first embodiment.

FIG. 4 illustrates a cross-sectional view of the sample holder in the first embodiment.

FIG. 5 illustrates another cross-sectional view of the sample holder in the first embodiment.

FIG. 6 illustrates a cross-sectional view of a sample holder in a first modification of the first embodiment.

FIG. 7 illustrates another cross-sectional view of the sample holder in the first modification of the first embodiment.

FIG. 8 illustrates a top view of a sample holder in a second modification of the first embodiment.

FIG. 9 illustrates a top view of a sample holder in a third modification of the first embodiment.

FIG. 10 illustrates a top view of the sample holder in the third modification of the first embodiment.

FIG. 11 illustrates a cross-sectional view of the sample holder in the third modification of the first embodiment.

FIG. 12 illustrates a perspective view of a sample holder in a second embodiment.

FIG. 13 illustrates a cross-sectional view of the sample holder in the second embodiment.

### DETAILED DESCRIPTION

A problem to be solved by the present invention is to provide a sample holder and an analysis system that are capable of inhibiting substances released from a sample subjected to laser ablation from adhering to a window capable of transmitting a laser beam, thus inhibiting a deterioration in the accuracy of an analysis.

In general, according to an embodiment, a sample holder includes a sample chamber, a laser guide, a first introduction pipe, and a delivery pipe. The sample chamber includes a surface having a through hole and configured to accommodate a sample therein along the surface. The laser guide extends in a first direction crossing the surface of the sample chamber between a first end connected to the through hole and a second end opposite to the first end. A window capable of transmitting a laser beam being provided at the second end of the laser guide. The first introduction pipe is provided on a first side of the sample chamber, and through the first introduction pipe a carrier gas is introduced into the sample chamber. The delivery pipe is provided on a second side of the sample chamber and through the delivery pipe a substance released from the sample by application of the laser beam is delivered.

An embodiment according to the present invention will be described below with reference to the drawings. The present embodiment is not intended to limit the present invention. The drawings are schematic or conceptual, and thus the proportions and the like of the respective parts illustrated in the drawings are not necessarily the same as those of the actual products. In the description and drawings, components identical to those described in foregoing drawings will be denoted by like reference characters, and detailed description thereof will be omitted as appropriate.

### First Embodiment

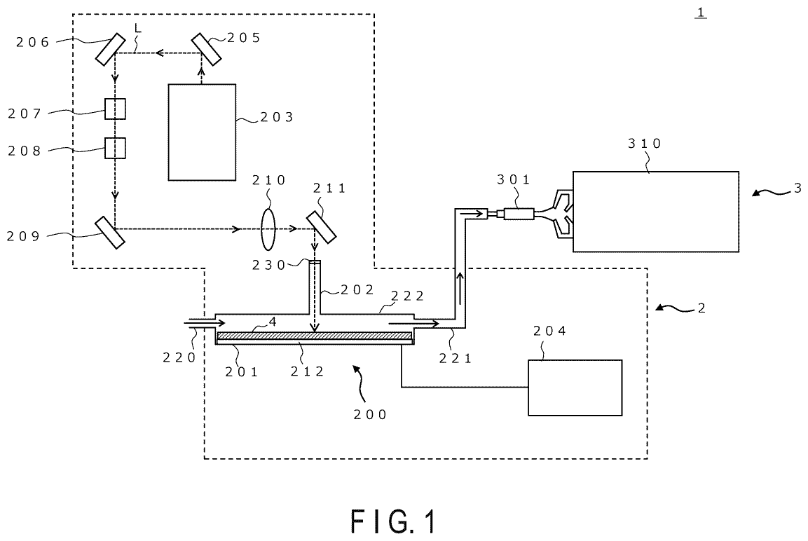

FIG. 1 is a diagram illustrating a configuration example of a laser ablation-inductively coupled plasma-mass spectrometer (LA-ICP-MS) system 1 according to a first embodiment. The LA-ICP-MS system 1 as an analysis system includes a laser ablation (LA) unit 2, and an inductively coupled plasma-mass spectrometer (ICP-MS) unit 3. The LA unit 2 encloses a sample chamber 201 and applies a laser beam L to a sample 4 to perform laser ablation. The laser ablation is a phenomenon in which the application of a laser beam to a surface of a material produces plasma and releases the constituents of the material at the surface. From the sample 4 subjected to the laser ablation, the constituents at the surface of the sample 4 are released into the sample chamber 201. The ICP-MS unit 3 ionizes, using the plasma, the constituents of the sample 4 released in the LA unit 2 and performs a quantitative analysis for elements contained in the sample. It is noted that the laser beam L is illustrated with dashed arrows in FIG. 1.

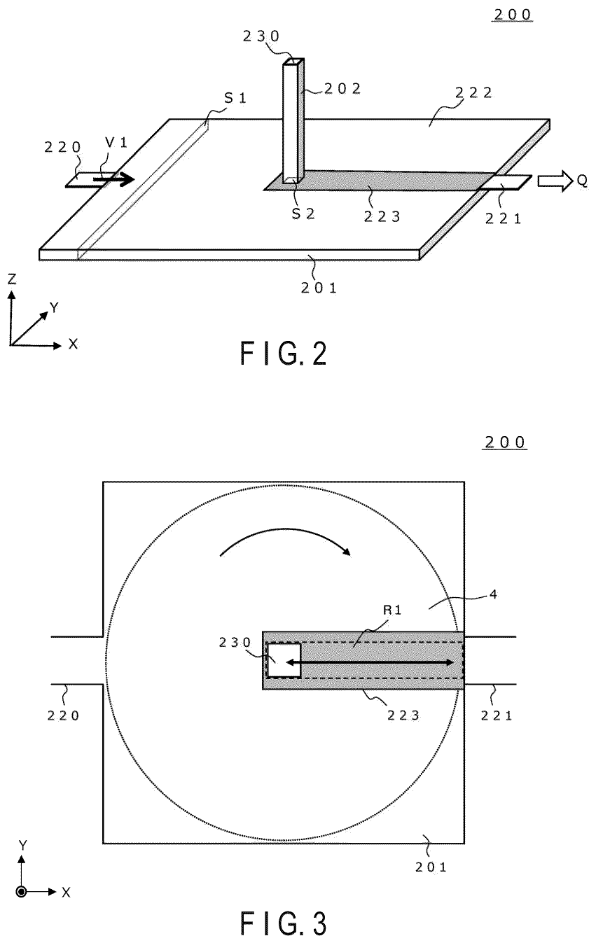

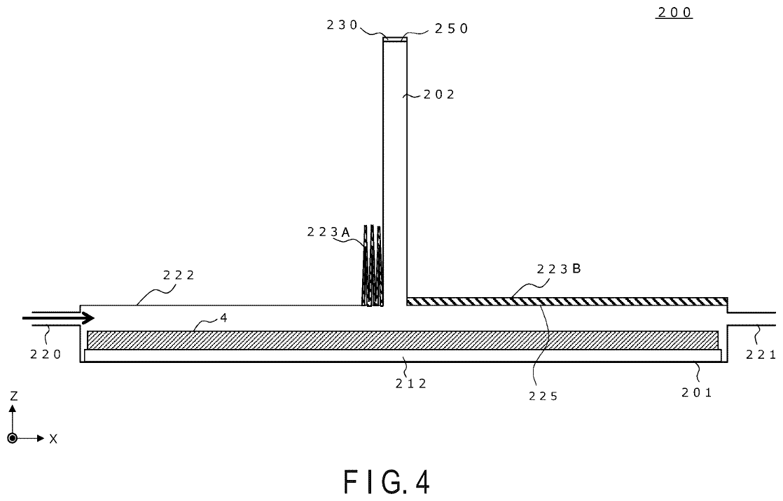

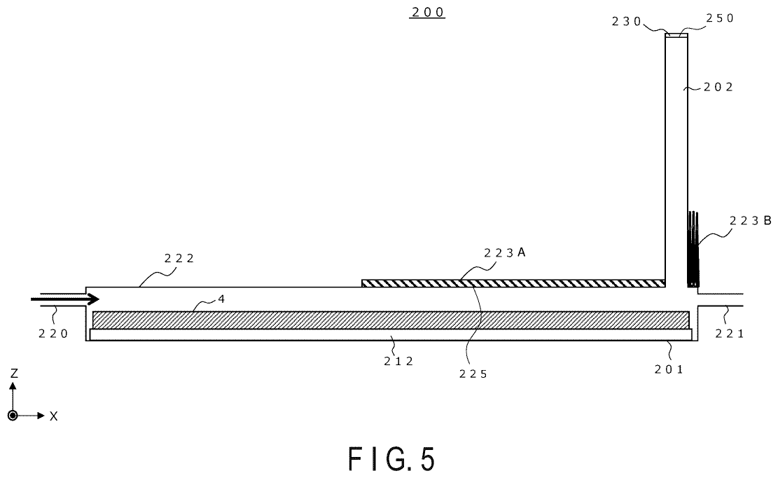

FIG. 2 to FIG. 5 illustrate a configuration example of a sample holder 200 in the first embodiment. Specifically, FIG. 2 illustrates a perspective view of the sample holder 200 in the first embodiment, and FIG. 3 illustrates a top view of the sample holder 200 in the first embodiment. FIG. 4 and FIG. 5 illustrate cross-sectional views of the sample holder 200 in the first embodiment. FIG. 5 illustrates a case where a cylindrical part 202 is moved to a position different from the position illustrated in FIG. 2 to FIG. 4 by a driving unit 223 described below.

The LA unit 2 includes the sample holder 200, a laser unit 203, a controller 204, mirrors 205, 206, 209, and 211, wavelength converters 207 and 208, and a lens 210.

The sample holder 200 includes the sample chamber 201, the cylindrical part 202, a stage 212, a first introduction pipe 220, a delivery pipe 221, the driving unit 223, and a window 230. Here, the direction from the first introduction pipe 220 toward the delivery pipe 221 is defined as an X-direction, the direction intersecting with the X-direction and extending along the stage 212 is defined as a Y-direction, and a direction intersecting with the X-direction and the Y-direction is defined as a Z-direction. The Z-direction is included in a first direction.

In the sample chamber 201, the stage 212, which allows the sample 4 being an analysis object to be loaded, is provided. The stage 212 is, for example, in the shape of a circle in an XY-plane and rotatable about the center of the circle. In the sample chamber 201, a first upper surface 222 from which the cylindrical part 202 described below protrudes may be detachably provided, or the sample chamber 201 and the first upper surface 222 may be provided such that the first upper surface 222 is not detachable.

In the sample chamber 201, for example, a wafer having a diameter of 300 mm can be loaded. The sample chamber 201 can be enclosed. The sample chamber 201 is enclosed while the sample 4 is subjected to the laser ablation.

The following will describe a case where the LA-ICP-MS system 1 allows a wafer having a diameter of 300 mm to be loaded in the sample chamber 201.

To the sample chamber 201, the first introduction pipe 220 and the delivery pipe 221 are connected. The first introduction pipe 220 introduces a carrier gas into the sample chamber 201. The carrier gas includes, for example, argon gas or helium gas. One end of the delivery pipe 221 is connected to the sample chamber 201, and the other end is connected to the ICP-MS unit 3. The delivery pipe 221 delivers the constituents of the sample 4 released by the laser beam L from the sample chamber 201 together with the carrier gas and carries the constituents to the ICP-MS unit 3. That is, the constituents of the sample 4 released by the application of the laser beam L are carried via the delivery pipe 221 to the ICP-MS unit 3 together with the carrier gas introduced into the sample chamber 201 by the first introduction pipe 220.

The flow volume of the carrier gas delivered from the delivery pipe 221 to the ICP-MS unit 3 needs to be a flow volume with which the accuracy of an analysis in the ICP-MS unit 3 described below can be kept. This is because an increase in the flow volume of the carrier gas delivered from the delivery pipe 221 to the ICP-MS unit 3 may decrease the sensitivity in the ICP-MS unit 3, resulting in a deterioration in the accuracy of the analysis. Specifically, the accuracy of the analysis in the ICP-MS unit 3 can be kept even in a case where the flow volume of the carrier gas increases by approximately 10% relative to a flow volume of the carrier gas that is suitable for the analysis in the ICP-MS unit 3 (hereinafter, referred to as optimal flow volume). It is noted that the flow volume of the carrier gas introduced from the first introduction pipe 220 to the sample chamber 201 is also set in accordance with the range of the flow volume of the carrier gas flowing into the ICP-MS unit 3.

As illustrated in FIG. 4 and FIG. 5, the driving unit 223 is provided on the first upper surface 222 of the sample chamber 201. FIG. 5 illustrates a case where the cylindrical part 202 is moved from its position illustrated in FIG. 4 by the driving unit 223 to be placed at a position close to the delivery pipe 221 in a region R1. The driving unit 223 includes an actuator (e.g., motor) (not individually illustrated) and a member having a surface 225 that is opposed to the sample 4. The driving unit 223 causes the cylindrical part 202 described below to move in an XY-plane while holding the cylindrical part 202. Specifically, the driving unit 223 causes the cylindrical part 202 to translate within the region R1 between the central portion of the first upper surface 222 and the delivery pipe 221. With the cylindrical part 202 provided in this manner, the laser ablation is performed on the sample 4 at a position relatively close to the delivery pipe 221 in the sample chamber 201. As a result, the constituents of the sample 4 released by the laser ablation are likely to be carried to the ICP-MS unit 3.

In the sample chamber 201, the sample 4 can be rotated by the stage 212 in the analysis. In the analysis, the driving unit 223 causes the cylindrical part 202 to move to a given location, and the cylindrical part 202 can thus be driven to a given location on the surface of the sample 4 for the application of the laser beam L.

The member of the driving unit 223 having the surface 225 is formed, for example, in the shape of a bellows and may constitute at least a part of the first upper surface 222. That is, the member of the driving unit 223 includes a bellows part 223A provided from a lateral surface of the cylindrical part 202 to the proximity to the central portion of the first upper surface 222 and a bellows part 223B provided from a lateral surface of the cylindrical part 202 to the proximity to the delivery pipe 221 on the first upper surface 222. In a case where the cylindrical part 202 is at the central portion of the first upper surface 222 as in FIG. 4, the bellows part 223A in the vicinity of the central portion of the first upper surface 222 is contracted. In a case where the cylindrical part 202 is in the vicinity of an edge of the first upper surface 222 as in FIG. 5, the bellows part 223B in the vicinity of the edge of the first upper surface 222 is contracted.

The member of the driving unit 223 formed in the shape of a bellows can make the space occupied by the driving unit 223 in the LA-ICP-MS system 1 small. As a result, the driving unit 223 does not hinder the delivery of the constituents released from the sample 4 subjected to laser ablation, resulting in an efficient delivery. In addition, this can produce the effect of downsizing the LA-ICP-MS system 1, for example.

The cylindrical part 202 is provided protruding in the Z-direction from the first upper surface 222 of the sample chamber 201. The cylindrical part 202 may be referred to as a laser guide. In other words, the cylindrical part 202 is provided such that the cylindrical part 202 is coupled to the sample chamber 201 at a portion of the first upper surface 222 and extends upward. In the upper surface of the cylindrical part 202, that is, a surface on the opposite side of the sample chamber 201 to the side on which the upper surface protrudes from the sample chamber 201, the window 230 is provided. The upper surface of the cylindrical part 202 is higher in the Z-direction than at least the first upper surface 222 of the sample chamber 201.

It is noted that the height of the cylindrical part 202 in the Z-direction is preferably within a working distance. The working distance in the present embodiment refers to a distance within which the oscillated laser beam L can reach the sample 4. For example, the height of the cylindrical part 202 can be increased to the extent that the cylindrical part 202 does not come into contact with the mirror 211. The cylindrical part 202 is included in a protruding part.

The XY cross section of the cylindrical part 202 may be in a quadrilateral shape or a circular shape. The XY cross section of the cylindrical part 202 may also be polygonal. The cylindrical part 202 may have a constant cross-sectional area from a portion at which the cylindrical part 202 is coupled to the first upper surface 222 to the surface in which the window 230 is provided or may be tapered from the portion at which the cylindrical part 202 is coupled to the first upper face 222 toward the face in which the window 230 is provided. The following will describe a case where the XY cross section of the cylindrical part 202 is in a quadrilateral shape, and the cylindrical part 202 has a constant cross-sectional area from the portion at which the cylindrical part 202 is coupled to the first upper surface 222 to the surface in which the window 230 is provided.

The window 230 is provided in the surface of the cylindrical part 202 on the opposite side of the cylindrical part 202 to a portion at which the cylindrical part 202 is coupled to the sample chamber 201. The window 230 is capable of transmitting the laser beam L. The window 230 transmits the laser beam L applied toward the sample chamber 201. The laser beam L transmitted by the window 230 is applied to the sample 4 under the window 230. It is noted that the surface of the cylindrical part 202 in which the window 230 is provided functions as a second upper surface 250 as illustrated in FIG. 4 and FIG. 5.

The shape of the window 230 in an XY-plane may be in a quadrilateral shape or a circular shape. The shape of the window 230 in the XY-plane may also be polygonal. The shape of the window 230 in the XY-plane may be the same as the XY cross section of the cylindrical part 202 or may be different from the XY cross section of the cylindrical part 202. The following will describe a case where the window 230 is in a quadrilateral shape in the XY-plane.

The size of the window 230 in the XY-plane may be the same as the size of the XY cross section of the cylindrical part 202 or may be smaller than the size of the XY cross section of the cylindrical part 202. The following will describe a case where the size of the window 230 in the XY-plane is the same as the size of the XY cross section of the cylindrical part 202.

In a default state, that is, in a case where the laser ablation is not performed, the cylindrical part 202 is placed at the central portion of the first upper surface 222 as in FIG. 4. In the case where the laser ablation is not performed, maintenance may be performed on the LA-ICP-MS system 1. In the maintenance, for example, the first introduction pipe 220 and the delivery pipe 221 are detached from the sample holder 200. In a case where the cylindrical part 202 is placed at a location on the first upper surface 222 close to the delivery pipe 221 in the default state as in FIG. 5, the cylindrical part 202 may interfere with another member (the first introduction pipe 220 or the delivery pipe 221) to be damaged in the maintenance. Placing the cylindrical part 202 at the central portion of the first upper surface 222 allows the cylindrical part 202 to be held on the first upper surface 222 without interfering with the other member in the maintenance.

At the start of the laser ablation, the cylindrical part 202 is preferably arranged in a region on the first upper surface 222 close to the delivery pipe 221 as in FIG. 5.

During the laser ablation, the LA-ICP-MS system 1 applies the laser beam L to a plurality of application target regions on the sample 4. The laser ablation performed on some application target region may cause a substance released from the sample 4 to adhere to the driving unit 223. More specifically, under the influence of the gas flow introduced from the first introduction pipe 220, substances released from the sample 4 adhere to a portion of the driving unit 223 that is opposed to the application target region and is located slightly shifted toward the delivery pipe 221 from a portion of the driving unit 223 directly above the application target region. As a result, in a case where the cylindrical part 202 is moved by the driving unit 223, the substances adhering to the driving unit 223 may fall down onto the sample 4, adhering to the sample 4.

Hence, in the present embodiment, the cylindrical part 202 is arranged at a place on the first upper surface 222 close to the delivery pipe 221 at the start of the laser ablation. That is, among the plurality of application target regions of the sample 4, an application target region that is the closest to the outer edge of the sample 4 (an application target region on an outer circumferential side) is first subjected to the laser ablation.

Next, the cylindrical part 202 is moved, or the sample 4 is rotated on the XY-plane to cause the laser ablation to be performed on an application target region located closer to the central portion of the sample 4 than the application target region on the outer circumferential side (an application target region on a central side).

In this laser ablation, the portion of the driving unit 223 to which substances released from the sample 4 in the laser ablation performed on the application target region on the outer circumferential side adhere is located at a place closer to the delivery pipe 221 than the portion of the driving unit 223 directly above the application target region on the central side. On the sample 4, the laser ablation has already been completed on a place closer to the delivery pipe 221 than the application target region on the central side. Therefore, if the substances adhering to the driving unit 223 fall down onto the sample 4, the substances will not affect the analysis in the application target region on the central side.

In other words, in the present embodiment, performing the laser ablation on the application target region on the outer circumferential side first out of the plurality of application target regions on the sample 4 can inhibit the substances falling down from the driving unit 223 from affecting the result of the analysis in the laser ablation in the application target region on the central side.

The laser unit 203 serving as a light source generates the laser beam L to be applied to the sample 4. For example, the laser unit 203 may be equipped with a Nd-YAG laser, which generates a laser beam with a wavelength of 1064 nm. In the LA unit 2, the laser beam L generated with a predetermined wavelength (e.g., a wavelength of 1064 nm) by the laser unit 203 is reflected by the mirrors 205 and 206 to enter the wavelength converter 207.

The wavelength converter 207 converts the wavelength of the laser beam L to 532 nm (the second harmonic). Thereafter, the wavelength converter 208 converts the wavelength of the laser beam L from 532 nm to 266 nm (the third harmonic). Making the laser beam L have a short wavelength increases the energy of the laser beam L, enabling the ablation to be performed on more substances.

In this manner, after its wavelength is halved by the wavelength converter 207 and further halved by the wavelength converter 208, the laser beam L is applied to the sample 4 in the sample chamber 201 via the mirror 209, the lens 210, and the mirror 211. The laser beam L is applied to the sample 4, ablating the sample 4.

The controller 204 controls the application condition of the laser beam L and the flow volume of the carrier gas to be introduced into the sample chamber 201. The controller 204 also controls the driving unit 223 to allow the laser ablation to be performed on a given location on the sample 4. Specifically, the controller 204 specifies a given location on the sample 4 and controls the driving unit 223 such that the cylindrical part 202 is placed over the location. Thereafter, the controller 204 performs control in such a manner as to introduce the carrier gas into the sample chamber 201 and apply the laser beam L from the laser unit 203 to the sample 4.

The controller 204 may be implemented with, for example, a personal computer or with a semiconductor chip such as a CPU. The controller 204 may be included in the LA unit 2 or may be provided separate from the LA unit 2. Alternatively, the controller 204 may be provided in the ICP-MS unit 3.

The ICP-MS unit 3 includes a plasma torch 301 and a mass spectrometry unit 310. The ICP-MS unit 3 performs a quantitative analysis on the gas from the sample chamber 201 to determine the content of a material (element) being an analysis object contained in the sample 4. The plasma torch 301 ionizes, using plasma, the sample 4 that is introduced together with the carrier gas from the delivery pipe 221. The mass spectrometry unit 310 is configured to extract and detect ions of the constituents of the sample 4 from the ionized gas. It is noted that the internal configuration of the mass spectrometry unit 310 has no direct relation to the present embodiment, and here will not be described the internal configuration in detail. Although the ICP-MS unit 3 is used in the present embodiment, an ICP-optical emission spectrometer (ICP-OES) may be used instead of the ICP-MS unit 3. In this case, an ICP-OES unit determines the content of a target element on a basis of light wavelengths (a spectrum) obtained from the released sample 4. The target element is, for example, a metallic element. The following will describe assuming that the ICP-MS unit 3 detects the metallic element contained in the sample 4.

In general, in an LA-ICP-MS, in a case where constituents released from a sample subjected to laser ablation adhere to a window, the constituents absorb the laser beam L to make the laser ablation insufficient, resulting in a deterioration in the accuracy of the analysis.

In the LA-ICP-MS system according to the first embodiment, the window 230 that can transmit the laser beam L is provided higher in the Z-direction than the first upper surface 222, and thus the sample 4 and the window 230 can be made distant from each other. Accordingly, it is possible to inhibit the constituents released from the sample 4 subjected to the laser ablation from adhering to the window 230, thus inhibiting a deterioration in the accuracy of the analysis.

Inhibiting the constituents released from the sample 4 subjected to the laser ablation from adhering to the window 230 will be further described in detail below.

The flow volume of the carrier gas introduced from the delivery pipe 221 to the ICP-MS unit 3 is determined in accordance with the flow rate of the carrier gas and the cross-sectional area of a container through which the carrier gas flows. As illustrated in FIG. 2, it is assumed that Q (mm³/min) denotes the flow volume of the carrier gas introduced from the delivery pipe 221 into the ICP-MS unit 3, V1 (mm/min) denotes the flow rate of the carrier gas introduced from the first introduction pipe 220 to the sample chamber 201, and S1 (mm²) denotes the cross-sectional area of the sample chamber 201. The cross-sectional area S1 is of a cross section of the sample chamber 201 that is substantially perpendicular to the flowing direction of the carrier gas introduced from the first introduction pipe 220. The flow volume Q can be calculated from Equation 1.

Q=V1×S1 (Equation 1)

Accordingly, the flow rate V1 (mm/min) of the carrier gas introduced from the first introduction pipe 220 to the sample chamber 201 and the cross-sectional area S1 (mm²) of the sample chamber 201 are set such that the flow volume Q of the carrier gas falls within the range from the optimal flow volume to 1.1 times the optimal flow volume.

In the present embodiment, a wafer having a diameter of 300 mm can be loaded in the sample chamber 201. Assuming that the height of the sample chamber 201 is 5 mm, S1 is 1500 mm², for example.

The flow volume Q of the carrier gas may be affected by the cross-sectional area S2 (mm²) of the cylindrical part 202 as well as the flow rate V1 and the cross-sectional area S1 of the sample chamber 201. The cross-sectional area S2 is of a cross section of the cylindrical part 202 that intersects with the first upper surface 222. In the present embodiment, a case where the cross-sectional area S2 and the area of the window 230 are substantially the same will be described.

Compared with the area of the first upper surface 222 of the sample chamber 201, the cross-sectional area S2 of the cylindrical part 202 is set to be significantly small. As a result, the cylindrical part 202 having the cross-sectional area S2 that is less than or equal to a predetermined area hardly allows the inflow of the carrier gas in a case where the carrier gas flows from the first introduction pipe 220 into the sample chamber 201. However, an increase in the cross-sectional area S2 of the cylindrical part 202 creates the possibility that the carrier gas flows into the cylindrical part 202 in a case where the carrier gas flows from the first introduction pipe 220 into the sample chamber 201. It is considered that this affects the flow volume Q of the carrier gas, resulting in a deterioration in the accuracy of an analysis in the ICP-MS unit 3.

In other words, the cross-sectional area S2 of the cylindrical part 202 less than or equal to the predetermined area is a cross-sectional area that makes it difficult for the carrier gas to flow in so that the flow volume Q of the carrier gas is kept at the optimal flow volume. In addition, the cross-sectional area S2 of the cylindrical part 202 less than or equal to the predetermined area is a cross-sectional area that can inhibit the substances released from the sample 4 by the laser ablation from adhering to the window 230.

Table 1 is an example of molar fractions (%) of the released constituents of the sample 4 adhering to the window 230 after a lapse of one second since the carrier gas flows from the first introduction pipe 220 into the sample chamber 201 in the first embodiment. It is noted that the area of the window 230 in the XY-plane is 100 mm², and the other conditions are the same as described above. Accordingly, it is assumed that the height of the sample chamber 201 in the Z-direction is 5 mm, and that S1 is 1500 mm². That is, the conditions shown in Table 1 are that the area of the window 230 in the XY-plane is 100 mm², the height of the sample chamber 201 in the Z-direction is 5 mm, and S1 is 1500 mm². In addition, the height of the cylindrical part 202 in the Z-direction (0 mm, 10 mm, 50 mm) is included in the conditions shown in Table 1.

TABLE 1
Table1

| | | | |
|---|---|---|---|
| HEIGHT [mm] OF CYLINDRICAL | 0 | 10 | 50 |
| PART 202 | | | |
| MOLAR FRACTION [%] OF | 10 | 4 | 0.004 |
| SUBSTANCE RELEASED FROM | | | |
| SAMPLE 4 SUBJECTED TO LASER | | | |
| ABLATION AND ADHERING TO | | | |
| WINDOW PART 230 | | | |
| RATIO, TAKING AS REFERENCE | 1 | 0.4 | 0.0004 |
| CASE WHERE HEIGHT OF | | | |
| CYLINDRICAL PART 202 IS 0 mm | | | |

As the height from the first upper surface 222 to the window 230 in the Z-direction is changed to 0 mm, 10 mm, and 50 mm, the molar fraction of the released constituents of the sample 4 adhering to the window 230 changes.

Table 1 also shows ratios relative to the amount of released constituents of the sample 4 adhering to the window 230 in a case where the height of the cylindrical part 202 is 0 mm, which is taken as 1. The released constituents of the sample 4 adhere to the window 230 at a ratio of 0.4 in a case where the height of the cylindrical part 202 is 10 mm and at a ratio of 0.0004 in a case where the height of the cylindrical part 202 is 50 mm.

In cases where the height of the cylindrical part 202 is 10 mm and 50 mm, the ratio of the sample 4 adhering to the window 230 after the lapse of one second since the carrier gas flows into the sample chamber 201 decreases compared with a case where the height of the cylindrical part 202 is 0 mm. Furthermore, in a case where the height of the cylindrical part 202 is 50 mm, the ratio of the sample 4 adhering to the window 230 after the lapse of one second since the carrier gas flows into the sample chamber 201 is one-thousandth of the ratio in the case where the height of the cylindrical part 202 is 10 mm. It can thus be understood that the ratio decreases significantly. That is, in a case where the sample chamber 201 is capable of accommodating a wafer having a diameter of 300 mm, and where the area of the window 230 in the XY-plane is 100 mm², setting the height of the cylindrical part 202 at 50 mm can significantly inhibit the window 230 from being contaminated.

As seen from the above, the substances released from the sample 4 subjected to the laser ablation and adhering to the window 230 decrease with an increase in the height of the cylindrical part 202. The effect of the decrease can be obtained prominently in a case where the height of the cylindrical part 202 is greater than or equal to 10 mm and can be obtained further prominently in a case where the height of the cylindrical part 202 is greater than or equal to 50 mm.

Assume that the size of the area of the window 230 in the XY-plane is proportional to the molar fraction of the released constituents of the sample 4 adhering to the window 230 in a case where only the area of the window 230 in the XY-plane is changed under the conditions shown in Table 1. In a case where the height of the cylindrical part 202 is 10 mm, the molar fraction of the sample 4 adhering to the window 230 having an area of 250 mm² is roughly equivalent to that in a case where the height of the cylindrical part 202 is 0 mm under the conditions shown in Table 1. Accordingly, the cross-sectional area S2 of the cylindrical part 202 less than or equal to the predetermined area is set at, for example, less than or equal to 250 mm². S2 being less than or equal to 250 mm² enables the flow volume Q of the carrier gas to be kept within the range of the optimal flow volume.

The window 230 is provided so as to be greater than or equal to 100 mm². This is because the size of a pattern region included in the sample 4 is approximately 100 mm², and such a window 230 enables the laser ablation of one pattern region to be collectively performed.

The area of the window 230, that is, S2, is greater than or equal to the area of the pattern region included in the sample 4. In addition, S2 is less than or equal to an area with which contaminants adhering to the window 230 are decreased compared with the case where the height of the cylindrical part 202 is 0 mm with the area of the window 230 being unchanged and the height of the cylindrical part 202 being changed. More specifically, S2 can be set within a range of 100 mm² to 250 mm², for example. In a case where the area of the XY cross section of the cylindrical part 202 is larger than the area of the XY cross section of the window 230, S2 may be larger than 250 mm².

In the LA-ICP-MS system 1 according to the present embodiment, the window 230 that can transmit the laser beam L is provided higher in the Z-direction than the first upper surface 222. Accordingly, the sample 4 and the window 230 can be made distant from each other, and it is thus possible to inhibit the sample 4 released by the laser beam L from adhering to the window 230 in the laser ablation of the sample 4.

In a case where the LA-ICP-MS system 1 according to the present embodiment includes the sample chamber 201 capable of accommodating a wafer, it is difficult to increase the height of the sample chamber 201 in the Z-direction compared with a case where the LA-ICP-MS system 1 including a sample chamber that accommodates a small piece. This is because the flow volume of the carrier gas delivered from the delivery pipe 221 to the ICP-MS unit 3 depends on the size of a YZ cross section of the sample chamber 201. If the flow volume of the carrier gas delivered from the delivery pipe 221 to the ICP-MS unit 3 is excessively large, the accuracy of an analysis in the ICP-MS unit 3 may deteriorate. In the present embodiment, providing the cylindrical part 202, which is connected to the first upper surface 222 of the sample chamber 201, can increase the distance in the Z-direction between the window 230 and the sample 4 without significantly increasing the flow volume of the carrier gas. Accordingly, it is possible to inhibit the window 230 from being contaminated while keeping the accuracy of an analysis in the ICP-MS unit 3.

### (First Modification of First Embodiment)

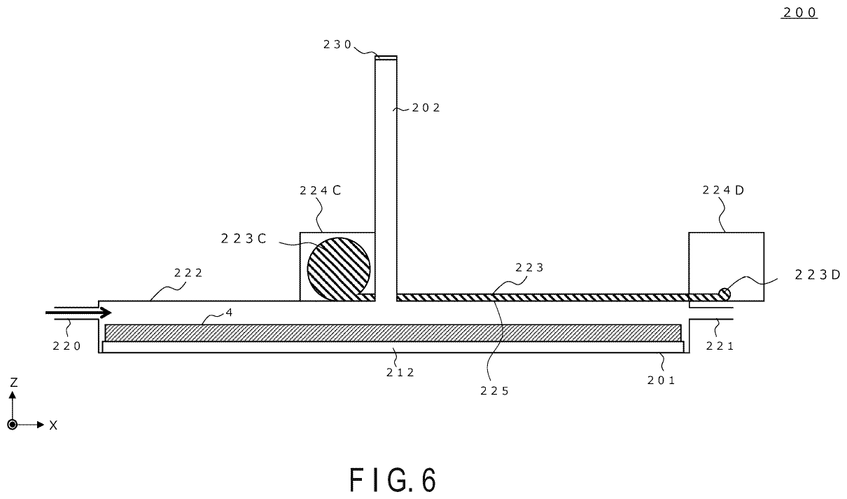

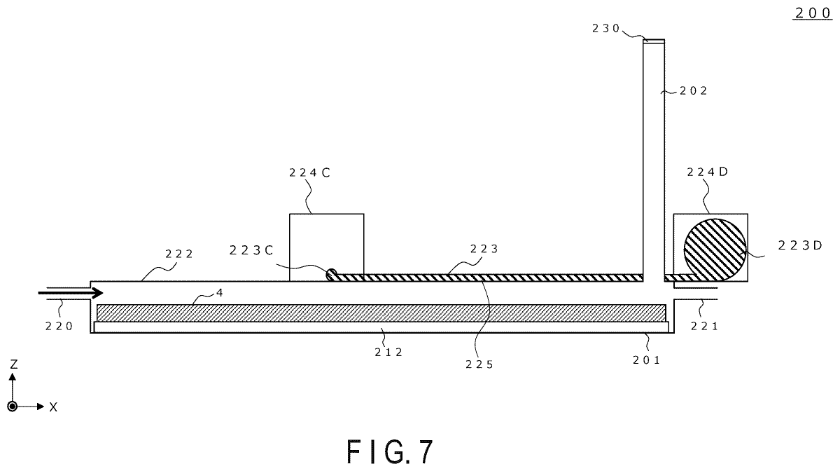

FIG. 6 and FIG. 7 illustrate cross-sectional views of a sample holder 200 in a first modification. FIG. 7 illustrates a case where a cylindrical part 202 is moved to a position different from a position illustrated in FIG. 6 by a driving unit 223 described below. The sample holder 200 and an LA-ICP-MS system 1 in the first modification have substantially the same configuration as in FIGS. 1 to 3, which illustrate the first embodiment.

The configuration of the LA-ICP-MS system 1 according to the first modification differs in the configuration of the sample holder 200. Specifically, in the first modification of the first embodiment, the driving unit 223 is provided with a winding unit 224C at one of the ends of the driving unit 223 and provided with a winding unit 224D at the other end. The driving unit 223 includes a belt 223C that is provided from a lateral surface of the cylindrical part 202 to the proximity to the central portion of a first upper surface 222 and a belt 223D that is provided from a lateral surface of the cylindrical part 202 to the proximity to a delivery pipe 221 on the first upper surface 222. In the following description, the winding units 224C and 224D may be collectively regarded as a winding unit 224.

The driving unit 223 includes the winding unit 224C provided on the first upper surface 222 and at a place close to the central portion of the first upper surface 222 and the winding unit 224D provided on the first upper surface 222 and at a place close to the delivery pipe 221. The winding unit 224C is capable of winding the belt 223C and feeding the belt 223C out of the winding unit 224C. The winding unit 224D is capable of winding the belt 223D and feeding the belt 223D out of the winding unit 224D.

In a case where the driving unit 223 including the winding unit 224 is provided in the sample holder 200, the cylindrical part 202 is moved as illustrated in FIGS. 6 and 7. The winding unit 224D provided in the vicinity of an edge of the first upper surface 222, that is, provided close to the delivery pipe 221 may be provided independently of the first upper surface 222, rather than on the first upper surface 222.

In a case where the cylindrical part 202 is at the central portion of the first upper surface 222 as in FIG. 6, the belt 223C in the vicinity of the central portion of the first upper surface 222 is wound by the winding unit 224C. At the same time, the belt 223D wound by the winding unit 224D is fed out of the winding unit 224D.

In a case where the cylindrical part 202 is in the vicinity of the edge of the first upper surface 222 as in FIG. 7, a large part of the belt 223D is wound by the winding unit 224D in the vicinity of the edge of the first upper surface 222. At the same time, the belt 223C wound by the winding unit 224C is fed out of the winding unit 224C. In this manner, the amounts of winding of the belts 223C and 223D are adjusted by the winding units 224C and 224D, respectively, to move the cylindrical part 202, and the cylindrical part 202 can thus be placed at a desired position in the region R1.

In the sample chamber 201, the sample 4 can be rotated by the stage 212 in the analysis as in the first embodiment. In the analysis, the driving unit 223 causes the cylindrical part 202 to move to a given location, and the cylindrical part 202 can thus be driven to a given location on the surface of the sample 4 for the application of the laser beam L.

In a case where the driving unit 223 includes the winding unit 224, the driving unit 223 can be provided flat. As a result, the released constituents of the sample 4 are unlikely to adhere to the surface 225 of the driving unit 223 opposed to the sample 4. Accordingly, in the case where the driving unit 223 includes the winding unit 224, it is possible to inhibit the driving unit 223 from being contaminated.

### (Second Modification of First Embodiment)

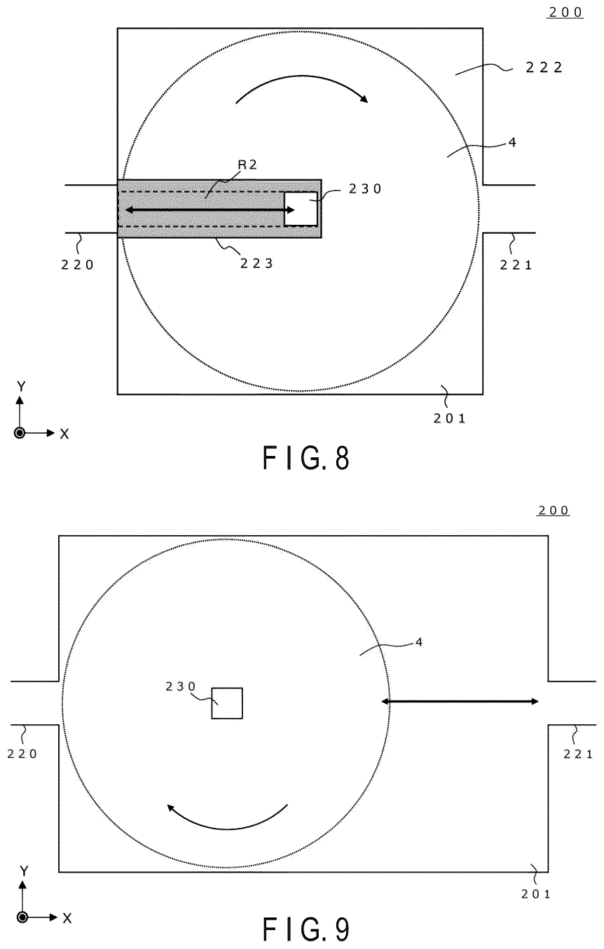

FIG. 8 is a top view illustrating a configuration example of a sample holder 200 in a second modification. The sample holder 200 and an LA-ICP-MS system 1 in the second modification have substantially the same configuration as in FIGS. 1 and 2 and FIGS. 4 and 5 illustrating the first embodiment except that the movable region of a driving unit 223 is a region R2.

The configuration of the LA-ICP-MS system 1 in the second modification differs in the configuration of the sample holder 200. Specifically, in the second modification, the driving unit 223 is provided such that the driving unit 223 translates a cylindrical part 202 within the region R2 between the central portion of a first upper surface 222 and a first introduction pipe 220. That is, the cylindrical part 202 is movable from the central portion of the sample chamber 201 to a location close to the first introduction pipe 220 in an XY-plane and allows the laser beam L to be applied to the sample 4 directly below the cylindrical part 202.

In the second modification also, in the sample chamber 201, the sample 4 can be rotated by the stage 212 in the analysis as in the first embodiment. In the analysis, the driving unit 223 causes the cylindrical part 202 to move to a given location, and the cylindrical part 202 can thus be driven to a given location on the surface of the sample 4 for the application of the laser beam L.

The driving unit 223 in the second modification can be provided as in the first embodiment or the first modification.

Providing the cylindrical part 202 such that the cylindrical part 202 can be translated within the region R2 allows the laser ablation to be performed on the sample 4 at a position relatively close to the first introduction pipe 220 in the sample chamber 201. As a result, even in a case where the constituents of the sample 4 released by the laser ablation adhere to the driving unit 223 and then fall down, the constituents are unlikely to be carried from the delivery pipe 221 to the ICP-MS unit 3. In a case where the laser ablation is performed at a desired location on the sample 4, this makes it possible to inhibit the sample 4 released by the laser ablation previously performed on another location and adhering to the driving unit 223 from being carried to the ICP-MS unit 3, enabling an accurate analysis.

At the start of the laser ablation, the cylindrical part 202 is preferably arranged in a region close to the central portion of the first upper surface 222.

As described above in the first embodiment, under the influence of the gas flow introduced from the first introduction pipe 220, substances released from the sample 4 may adhere to the portion of the driving unit 223 that is opposed to the application target region and is located slightly shifted toward the delivery pipe 221 from the portion of the driving unit 223 directly above the application target region.

In a case where the cylindrical part 202 is moved by the driving unit 223, the substances adhering to the driving unit 223 may fall down onto the sample 4, adhering to the sample 4.

Hence, in the present modification, the cylindrical part 202 is arranged at a place close to the central portion of the first upper surface 222 at the start of the laser ablation. That is, the laser ablation is first performed on an application target region that is located the closest to the central portion of the sample 4 among the plurality of application target regions of the sample 4 (an application target region on a central side).

Next, the cylindrical part 202 is moved, or the sample 4 is rotated on the XY-plane to cause the laser ablation to be performed on an application target region located closer to the outer circumference of the sample 4 than the application target region on the central portion side (an application target region on the outer circumferential side).

In this laser ablation, the portion of the driving unit 223 to which substances released from the sample 4 in the laser ablation performed on the application target region on the central side adhere is located at a place closer to the delivery pipe 221 than the portion of the driving unit 223 directly above the application target region on the outer circumferential side. On the sample 4, the laser ablation has already been completed on a place closer to the delivery pipe 221 than the application target region on the outer circumferential side. Therefore, if the substances adhering to the driving unit 223 fall down onto the sample 4, the substances will not affect the analysis in the application target region on the outer circumferential side.

In other words, in the present modification, performing the laser ablation in the application target region on the central portion side first out of the plurality of application target regions on the sample 4 can inhibit the substances falling down from the driving unit 223 from affecting the result of the analysis in the laser ablation in the application target region on the outer circumferential side.

### (Third Modification of First Embodiment)

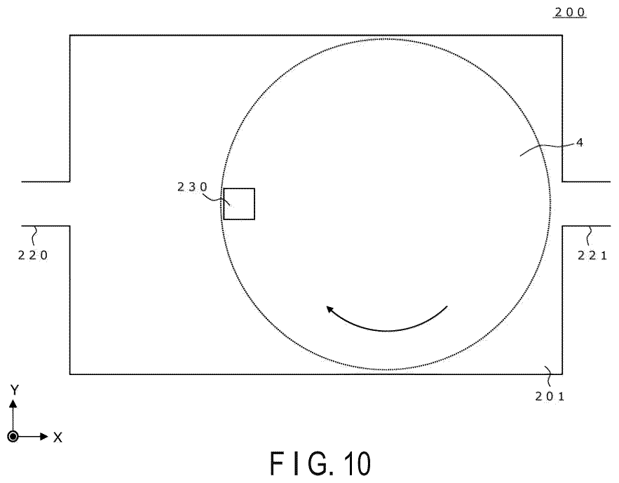

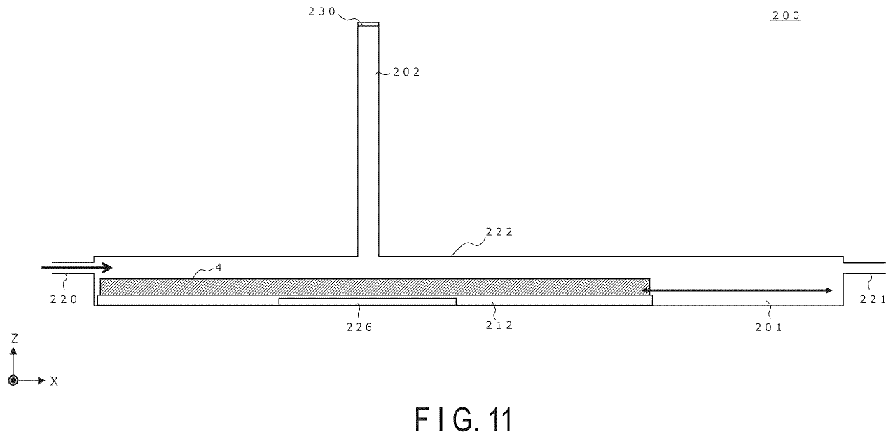

FIG. 9 and FIG. 10 are top views each illustrating a configuration example of a sample holder 200 in a third modification. FIG. 11 is a cross-sectional view illustrating a configuration example of the sample holder 200 in the third modification.

The configuration of the LA-ICP-MS system 1 in the third modification differs in the configuration of the sample holder 200. Specifically, the sample chamber 201 is provided in a rectangular shape as viewed from the Z-direction. In addition, the stage 212 is provided with a driving unit 226.

The driving unit 226 provided in the stage 212 causes the stage 212 to move such that the stage 212 translates in an XY-plane. That is, the driving unit 226 enables the stage 212 to translate in the XY-plane in the sample chamber 201. This causes the sample 4 mounted on the stage 212 to translate in an XY-plane in accordance with the translation of the stage 212 in the sample chamber 201. In the following description, a state in which the stage 212 is placed close to the first introduction pipe 220 as in FIG. 9 is regarded as an initial position.

More specifically, the driving unit 226 causes the stage 212 to move along with the sample 4 thereon, which is mounted on the stage 212, so as to bring the stage 212 and the sample 4 close to the first introduction pipe 220 or close to the delivery pipe 221. This makes the area of the sample chamber 201 in an XY-plane approximately 1.5 times the area of the sample 4 in an XY-plane.

For example, the driving unit 226 is provided inside the stage 212 or on a surface on which the stage 212 is provided in the sample chamber 201. For example, on a surface on which the stage 212 is provided in the sample chamber 201, the driving unit 226 includes a rail not illustrated. As the driving unit 226 moves on the rail not illustrated, the stage 212 translates on an XY-plane.

In the third modification also, in the sample chamber 201, the sample 4 can be rotated by the stage 212 in the analysis as in the first embodiment. In the analysis, the driving unit 226 causes the stage 212 to move to a given location, and the laser beam L can thus be applied to a given location on the surface of the sample 4. In this application, the position of the cylindrical part 202 is fixed. Specifically, as in FIG. 9, the cylindrical part 202 is provided such that the cylindrical part 202 overlaps the central portion of the sample 4 in top view in a state where the stage 212 is placed at the initial position. Since the area of the sample chamber 201 in an XY-plane is approximately 1.5 times the area of the sample 4 in an XY-plane, when the stage 212 is moved close to the delivery pipe 221, the sample 4 is moved from the initial position toward the delivery pipe 221 by approximately the radius of the sample 4. Accordingly, the cylindrical part 202 overlaps the outer circumferential portion of the sample 4 in top view as in FIG. 10.

By fixing the cylindrical part 202 at the above-mentioned position and providing the stage 212 such that the stage 212 is rotatable in an XY-plane and movable in the X-direction, the laser beam L can be applied to a given location on the surface of the sample 4. Although not illustrated, the cylindrical part 202 may be provided such that the cylindrical part 202 overlaps the central portion of the sample 4 in top view in a case where the sample 4 is moved from the initial position toward the delivery pipe 221 by approximately the radius of the sample 4 as in FIG. 10. In this case also, in a case where the sample 4 is placed at the initial position, the cylindrical part 202 overlaps the outer circumferential portion of the sample 4 in top view. Accordingly, the laser beam L can be applied to a given location on the surface of the sample 4.

In the third modification, the sample chamber 201 is extended in the flowing direction of the gas, that is, the X-direction, compared with the first embodiment. As a result, the cross-sectional area S1 (mm²) of the sample chamber 201, which affects the flow volume of the carrier gas delivered from the delivery pipe 221 to the ICP-MS unit 3 is the same as in the first embodiment. Accordingly, although the volume of the sample chamber 201 is large compared with that in the first embodiment, the influence of an increase in the flow volume of the carrier gas delivered from the delivery pipe 221 to the ICP-MS unit 3 is curbed.

The third modification can provide the same effects as the first embodiment. By extending the sample chamber 201 in the X-direction, it is possible to place the sample 4 such that the laser beam L can be applied to a given location on the surface of the sample 4 while curbing the influence on the flow volume of the carrier gas delivered from the delivery pipe 221 to the ICP-MS unit 3.

It is noted that members not described in the third modification may be the same as those in the first embodiment.

### Second Embodiment

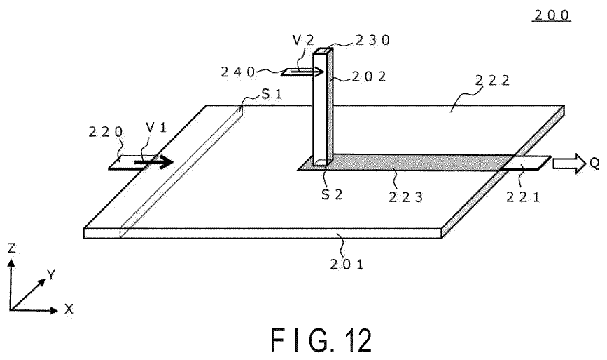

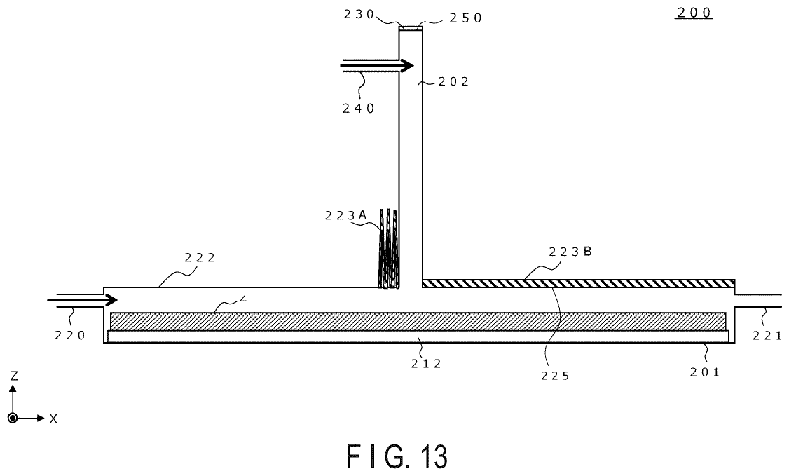

FIG. 12 is a perspective view illustrating a configuration example of a sample holder 200 in a second embodiment, and FIG. 13 is a cross-sectional view illustrating the configuration example of the sample holder 200 in the second embodiment.

The second embodiment differs from the first embodiment in that a cylindrical part 202 is provided with a second introduction pipe 240 to introduce the carrier gas.

The second introduction pipe 240 is provided connected to a lateral surface of the cylindrical part 202. The second introduction pipe 240 is provided at a position higher than at least the first introduction pipe 220 in the Z-direction. In a case where the carrier gas is introduced from the first introduction pipe 220 to the sample chamber 201, a gas is also introduced from the second introduction pipe 240 to the cylindrical part 202.

The gas introduced from the second introduction pipe 240 is of the same type (i.e., has a same gas composition) as the carrier gas introduced from the first introduction pipe 220. That is, in a case where the carrier gas introduced from the first introduction pipe 220 includes helium gas, the gas introduced from the second introduction pipe 240 also includes helium gas. In a case where the carrier gas introduced from the first introduction pipe 220 includes argon gas, the gas introduced from the second introduction pipe 240 also includes argon gas.

The introduction of the gas from the second introduction pipe 240 into the cylindrical part 202 affects the flow volume of the carrier gas delivered from the delivery pipe 221 to the ICP-MS unit 3. As in the first embodiment, Q (mm³/min) denotes the flow volume of the carrier gas delivered from the delivery pipe 221 to the ICP-MS unit 3. The flow volume Q is the sum of a flow volume Q1 (mm³/min) of the carrier gas introduced from the first introduction pipe 220 into the sample chamber 201 and a flow volume Q2 (mm³/min) of the gas introduced from the second introduction pipe 240 into the cylindrical part 202.

The flow volume Q1 can be calculated using Equation 2 with the flow rate V1 (mm/min) of the carrier gas introduced from the first introduction pipe 220 into the sample chamber 201 and the cross-sectional area S1 (mm²) of the sample chamber 201. In addition, assuming that V2 (mm/min) denotes the flow rate of the gas introduced from the second introduction pipe 240 into the cylindrical part 202, the flow volume Q2 (mm²) can be calculated using the cross-sectional area S2 and Equation 3. Accordingly, the flow volume Q can be calculated from Equation 4. It is noted that the definition of the cross-sectional areas S1 and S2 may be the same as those in the first embodiment.

$$Q 1 = V 1 \times S 1 \qquad ( Equation 2 )$$

$$Q 2 = V 2 \times S 2 \qquad ( Equation 3 )$$

$$Q = V 1 \times S 1 + V 2 \times S 2 \qquad ( Equation 4 )$$

As in the first embodiment, the flow volume Q affects the accuracy of an analysis in the ICP-MS unit 3, and thus the flow volume Q needs to be within the range from the optimal flow volume to 1.1 times the optimal flow volume. Accordingly, in a case where the flow volume Q1 is the same as the optimal flow volume, the flow volume Q2 is approximately 1/10 of the flow volume Q1. The following will describe a case where the flow volume Q2 is less than or equal to 1/10 of the flow volume Q1.

In the present embodiment, a wafer having a diameter of 300 mm can be loaded in the sample chamber 201. Assuming that the height of the sample chamber 201 is 5 mm, S1 is 1500 mm², for example.

In the present embodiment, a case where the cross-sectional area S2 and the area of the window 230 are substantially the same will be described. Compared with the area of the first upper surface 222 of the sample chamber 201, the cross-sectional area S2 of the cylindrical part 202 is set to be significantly small. S2 can be set within a range of 100 mm² to 250 mm², for example, as in the first embodiment.

Accordingly, with S1 being 1500 mm², S2 being greater than or equal to 100 mm², and Q2 being less than or equal to 1/10 of Q1, V2 is less than or equal to 3/2 of V1 according to Equation 2 and Equation 3. That is, in a case where the gas is introduced from the second introduction pipe 240 to the cylindrical part 202, the flow rate V2 of the gas from the second introduction pipe 240 is set, for example, within the range of less than or equal to 3/2 of the flow rate V1 of the carrier gas introduced from the first introduction pipe 220 to the sample chamber 201.

The other constituent components are the same as those in the first embodiment, and the description thereof will be omitted.

The second embodiment can provide the same effects as the first embodiment. In the second embodiment, the cylindrical part 202 is provided with the second introduction pipe 240 to introduce the gas, and thus the released constituents of the sample 4 can be further inhibited from entering the cylindrical part 202. Accordingly, it is possible to further inhibit the released sample 4 from adhering to the window 230.

It is noted that members not described in the present embodiment may be the same as those in the first embodiment. Members not described in the present embodiment may be the same as those in any one of the modifications of the first embodiment.

According to at least any one of the embodiments described above in detail, by providing the second upper surface of the cylindrical part with the window capable of transmitting the laser beam L, it is possible to inhibit substances released from the sample subjected to the laser ablation from adhering to the window, thus inhibiting the accuracy of an analysis from deteriorating.

There is prepared an analysis system including: the sample chamber 201 that is capable of accommodating the stage 212 configured to hold the sample 4 and includes a surface having a through hole above a surface at which the stage 212 is in contact with the sample 4; the cylindrical part 202 that is provided protruding upward from the through hole of the sample chamber 201 in the first direction (Z-direction) intersecting with the surface having the through hole and includes, in its upper surface, the window 230 capable of transmitting the laser beam L to be applied to the sample 4; the first introduction pipe 220 that is provided at the one end side of the sample chamber 201 and is capable of introducing the carrier gas to the sample 4 to which the laser beam L is to be applied; and the delivery pipe 221 that is provided at the other end side of the sample chamber 201 and is capable of delivering substances to be released from the sample 4 by the application of the laser beam L. The sample 4 is mounted on the stage 212, the sample chamber 201 is enclosed, and the gas is introduced into the sample chamber 201 from the first introduction pipe 220. The laser beam L is applied toward the first region on the sample 4 from the laser unit 203 serving as a light source, substances released from the sample 4 by the application of the laser beam L are delivered from the delivery pipe 221, and the relative position between the sample 4 and the cylindrical part 202 is then changed by moving the cylindrical part 202 or moving the stage 212. The laser beam L is then applied toward the second region on the sample 4, different from the first region, from the laser unit 203 serving as the light source.

While certain embodiments have been described, these embodiments have been presented by way of example only, and are not intended to limit the scope of the inventions. Indeed, the novel devices and methods described herein may be embodied in a variety of other forms; furthermore, various omissions, substitutions, and changes in the form of the embodiments described herein may be made without departing from the spirit of the inventions. The accompanying claims and their equivalents are intended to cover such forms or modification as would fall within the scope and spirit of the inventions.

What is claimed is:

1. A sample holder comprising:
a sample chamber including a surface having a through hole and configured to accommodate a sample along the surface;
a laser guide extending in a first direction crossing the surface of the sample chamber between a first end connected to the through hole and a second end opposite to the first end, a window capable of transmitting a laser beam being provided at the second end of the laser guide;
a first introduction pipe that is provided on a first side of the sample chamber and through which a carrier gas is introduced into the sample chamber; and
a delivery pipe that is provided on a second side of the sample chamber and through which a substance released from the sample by application of the laser beam is delivered.

2. The sample holder of claim 1, wherein the sample chamber is capable of accommodating a wafer having a diameter of 300 mm.

3. The sample holder of claim 2, wherein a length of the laser guide in the first direction is greater than or equal to 10 mm.

4. The sample holder of claim 1, further comprising a second introduction pipe that is connected to the laser guide and through which a gas is introduced into the laser guide.

5. The sample holder of claim 4, wherein the carrier gas introduced from the first introduction pipe and the gas introduced from the second introduction pipe have a same gas composition.

6. The sample holder of claim 1, further comprising an actuator configured to cause the laser guide to move in a direction along the surface of the sample chamber.

7. The sample holder of claim 6, wherein at least a part of the surface of the sample chamber is formed with bellows and the actuator is configured to cause the bellows to transform when the laser guide is moved.

8. The sample holder of claim 6, wherein at least a part of the surface of the sample chamber is formed with a belt and the actuator is configured to cause the belt to be wound when the laser guide is moved.

9. The sample holder of claim 1, further comprising:
a sample stage provided in the sample chamber and configured to hold the sample along the surface of the sample chamber; and
an actuator configured to move the sample stage in a direction along the surface of the sample chamber.

10. The sample holder of claim 9, wherein
the sample chamber is rectangular as viewed from the first direction, and
the first side of the sample chamber on which the first introduction pipe is provided is a short side.

11. The sample holder of claim 1, wherein
the second side of the sample chamber is opposite to the first side of the sample chamber.

12. The sample holder of claim 11, wherein a location of the laser guide is variable along a line connecting the first introduction pipe and the delivery pipe as viewed from the first direction.

13. The sample holder of claim 12, wherein the sample chamber is rectangular parallelepiped.

14. The sample holder of claim 1, wherein the sample chamber is enclosed in a case where the laser beam is applied.

15. An analysis system comprising:
the sample holder of claim 1;
a light source configured to generate the laser beam; and
an analyzer configured to analyze the substance delivered through the delivery pipe by an inductively coupled plasma method.

16. The analysis system of claim 15, wherein the analyzer is configured to ionize, using plasma, the substance released from the sample and perform a quantitative analysis for elements contained in the sample.

17. A method for analyzing a sample, comprising:
preparing a sample holder including:
a sample chamber including a surface having a through hole;
a laser guide extending in a first direction crossing the surface of the sample chamber between a first end connected to the through hole and a second end opposite to the first end, a window capable of transmitting a laser beam being provided at the second end of the laser guide;
a first introduction pipe provided on a first side of the sample chamber; and
a delivery pipe provided on a second side of the sample chamber;
mounting the sample in the sample chamber along the surface;
enclosing the sample chamber;
introducing a gas into the sample chamber from the first introduction pipe;
applying a laser beam from a light source toward a first region of the sample through the window and the laser guide;
delivering, from the sample chamber, a substance released from the sample by application of the laser beam;
changing a relative position of the laser guide with respect to the sample;
applying the laser beam from the light source toward a second region of the sample through the window and the laser guide, the second region being different from the first region; and
analyzing the delivered substance by an inductively coupled plasma method.

18. The method of claim 17, wherein
the sample includes a pattern region, and
an area of the window is greater than or equal to an area of the pattern region as viewed from the first direction.

19. The method of claim 17, wherein said changing the relative position of the laser guide with respect to the sample comprises moving the laser guide along the surface of the sample chamber.

20. The method of claim 17, wherein said changing the relative position of the laser guide with respect to the sample comprises moving a stage that is provided in the sample chamber and on which the sample is held along the surface of the sample chamber.
